(19) United States
(12) Patent Application Publication
(10) Pub. No.: US 2007/0171993 A1
(43) Pub. Date: Jul. 26, 2007

(54) Adaptive overlap and add circuit and method for zero-padding OFDM system

(75) Inventors: Jyh-Ting Lai, Hsinchu City (TW); Chun-Nan Ke, Taichung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Faraday Technology Corp.

(21) Appl. No.: 11/337,622

(22) Filed: Jan. 23, 2006

(51) Int. Cl. H04K 1/10

(52) U.S. Cl. 375/260

(57) ABSTRACT

The invention relates to an Overlap and Add circuit, and in particular, an adaptive Overlap and Add circuit. The adaptive OLA circuit comprises a detection unit, an estimator, and an OLA circuit. The detection unit estimates a channel property according to an OFDM signal received through a channel. The estimator estimates an OLA length in a current OFDM symbol of an OFDM signal according to a channel property. The OLA circuit copies an OLA signal to an FFT window in the current symbol according to the OLA length.

### BACKGROUND

The invention relates to an Overlap and Add circuit, and in particular, to an adaptive Overlap and Add circuit.

Orthogonal Frequency Division Multiplexing (OFDM) is an efficient multi-channel modulation technology utilizing Inverse Fast Fourier Transform (IFFT) and Fast Fourier Transform (FFT) to modulate and demodulate signals in the transmitter and in the receiver respectively with a plurality of orthogonal sub-channel carriers. In the traditional OFDM system, the transmitter always copies the tail part of each OFDM symbol to its beginning part. The copied part is called the cyclic prefix (CP). In a next generation OFDM system (e.g. IEEE 802.15 for MB-OFDM or IEEE 802.11n for next generation WLAN), the CP is however replaced with zero-padding (ZP). In other words, the tail part of each OFDM symbol will not be copied to the beginning of the next symbol in the transmitter. A detailed description of the zero-padding OFDM system is provided as follows:

Please refer to FIG. 1. FIG. 1 shows a schematic diagram of transmitted and received OFDM symbols in a zero-padding OFDM system. In the transmitter (not shown), a zero-padding signal S_ZP is transmitted with the transmitted OFDM symbol S_IFFT_O/P. In a receiver (not shown), an OFDM symbol S_FFT_I/P is received through the channel. The received OFDM symbol S_FFT_I/P is equal to the convolution of the transmitted OFDM symbol S_IFFT_O/P from the-transmitter and the Channel Impulse Response. After the receiver finds a best FFT window S_WINDOW of the OFDM symbol S_FFT_I/P, the tail part of the OFDM symbol S_FFT_I/P is taken as an Overlap and Add signal S_OLA and the Overlap and-Add signal S_OLA is copied and added to the beginning of zero-padding signal S_ZP. It can also be said that the Overlap and Add signals_OLA is copied to the beginning of the FFT window S_WINDOW since the Overlap and Add signal S_OLA is received with the transmitted OFDM symbol S_IFFT_O/P. This copy technology is called Overlap and Add (OLA). By utilizing OLA technology, the received signal in the FFT window can be expressed as the circular convolution of the original signal in the FFT window and the Channel Impulse Response. Therefore the signal-performed with the OLA technology can be handled by traditional cyclic prefix receiver. However, the OLA technology may sometimes operate improperly since the data length of the copied signal S_OLA is always fixed but the channel properties (e.g. Channel Impulse Response) are time variant. A detailed description of OLA operation in different Channel Impulse Responses is provided as follows:

Please refer to FIG. 2. FIG. 2 show waveform of the received OFDM signals S_IN_1 and S_IN 2 in different Channel Impulse Responses according to related art. The received OFDM signal comprises a plurality of OFDM symbols. Each OFDM symbol comprises post-cursors, an FFT window, and pre-cursors. Segments 202, 208, 214, 220 are pre-cursors; segments 204, 210, 216, 222 are FFT windows; and segments 206, 212, 218, 224 are post-cursors. The lengths of post-cursor and pre-cursor are both dependent on the channel properties. In other words, both post-cursor and pre-cursor vary with Channel Impulse Response. The OFDM signal S_IN_1 shows a case of a longer post-cursor (compared with a pre-cursor) and the OFDM signal S_IN_2 shows another case of a longer pre-cursor (compared with a post-cursor). A detailed description of OLA operation with different post-cursor and pre-cursor lengths is provided as follows:

Assume that the default length of Overlap and Add signal S_OLA in OLA technology is equal to the length of the longer post-cursor 206. In the OFDM signal S_IN_1, the longer post-cursor 206 will be fully copied and added to the beginning of the FFT window 204 of a first-coming OFDM symbol. By the same way, the pre-cursor part 202 is also copied and added to the tailed part of the FFT window 204. However, in the OFDM signal S_IN_2, not only the shorter post-cursor 218 will be copied to the beginning of the FFT window 216 in first-coming OFDM symbol but also a part 402 of the pre-cursor 220 of next coming OFDM symbol will be copied to the FFT window of the first OFDM symbol. Since the default length of Overlap and Add signal S_OLA is larger than the length of the post-cursor 218, an extra part 402 and the actually needed post-cursor 218 are both copied to the FFT window 216 and causes error. Moreover, only part of pre-cursor 214b is copied and added to the FFT window, and the system performance will be seriously degraded. In other words, the OLA technology operates improperly in the received OFDM signal S_IN_2 due to the mismatch of post-cursor length and a default OLA length.

### SUMMARY

The invention provides an adaptive OLA circuit for a zero-padding OFDM system. The zero-padding OFDM system comprises a transmitter, a channel and a receiver. The transmitter transmits an OFDM signal and the receiver receives the OFDM signal through the channel. The received OFDM signal comprises a plurality of OFDM symbols. Each OFDM symbol comprises post-cursors, an FFT window and pre-cursor segments. Lengths of the pre-cursors and the pre-cursors are dependent on the channel property of the channel. The adaptive OLA circuit comprises a detection unit, an estimator, and an OLA circuit. The detection unit estimates the channel property according to the OFDM signal received through the channel. The estimator estimates an OLA length in a current OFDM symbol of the OFDM signal-according to the channel property. The OLA circuit copies an OLA signal to the FFT window in the current symbol according to the OLA length.

The invention further provides an adaptive OLA method for an adaptive OLA circuit in a zero-padding OFDM system. The zero-padding OFDM system comprises a transmitter, a channel, and-a receiver. The transmitter transmits an OFDM signal and the receiver receives the OFDM signal through the channel. The OFDM signal comprises a plurality of OFDM symbols. Each received OFDM symbol comprises post-cursors, an FFT window, and pre-cursor segments. Lengths of the pre-cursors and the pre-cursors are-dependent on a channel property of the channel. The adaptive OLA method comprises: estimating the channel property according to the OFDM signal received through the channel; estimating an OLA length in a current OFDM symbol of the OFDM signal according to the channel property; copying and adding an OLA signal to the FFT window in the current symbol according to the OLA length.

### DESCRIPTION OF THE DRAWINGS

The following detailed description, given by way of example and not intended to limit the invention solely to the embodiments described herein, will best be understood in conjunction with the accompanying drawings, in which:

FIG. 1 shows the schematic diagram of transmitted and received OFDM symbols in a conventional zero-padding OFDM system;

FIG. 2 shows the waveform of the received OFDM signals in different Channel Impulse Responses according to the related art;

FIG. 3 shows the block diagram of an adaptive OLA circuit applied in a receiver of zero-padding OFDM system according to an embodiment of the invention;

FIG. 4 is the flowchart illustrating adaptive Overlap and Add method utilized in the adaptive OLA circuit according to another embodiment of the invention;

FIG. 5A and FIG. 5B show the waveform of the estimated Channel Impulse Response and its corresponding summation signal according to the invention.

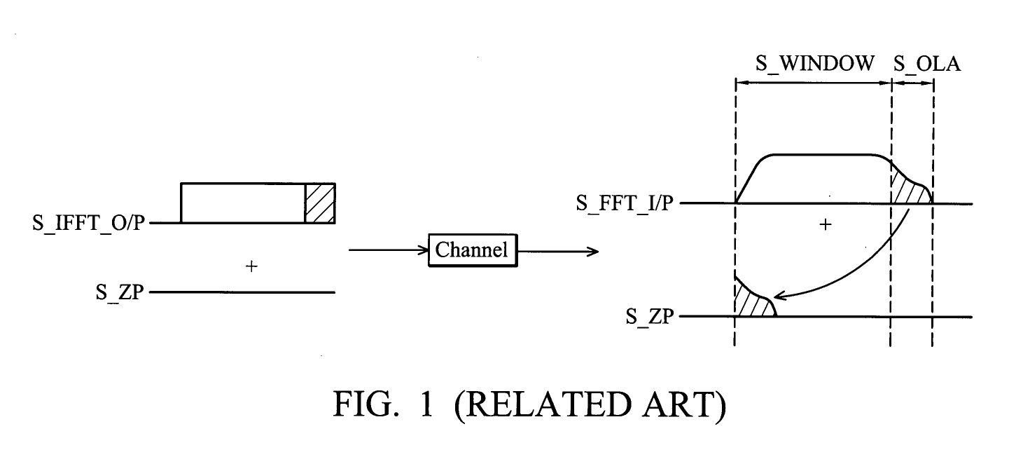

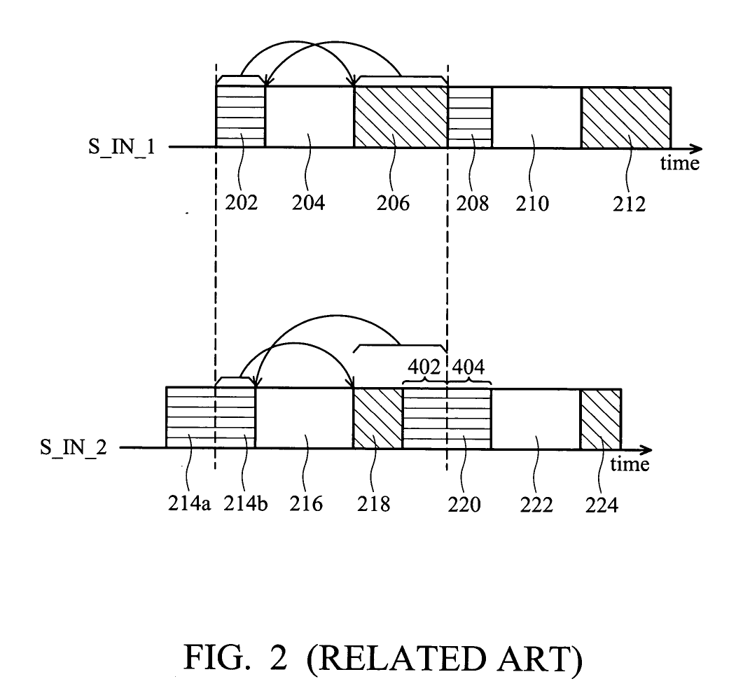

### DESCRIPTION

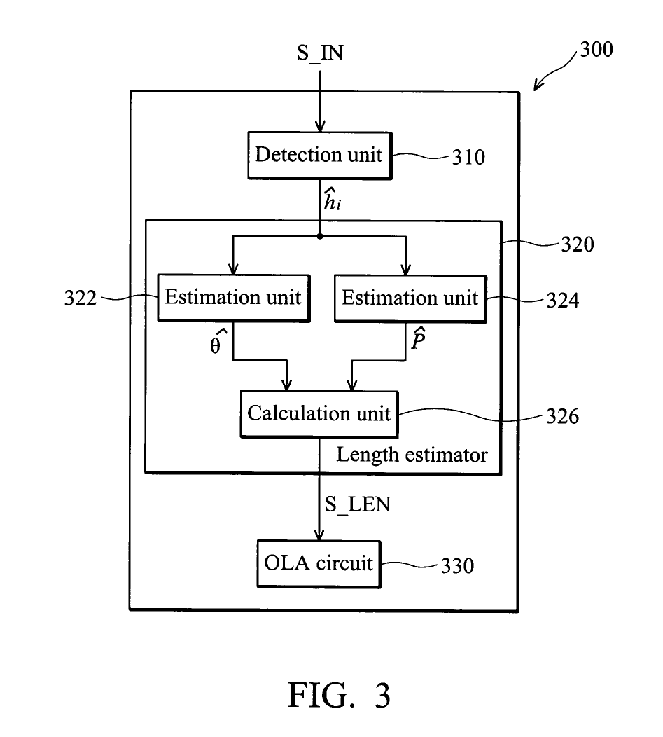

A detailed description of the invention is provided as follows: An adaptive Overlap and Add (Adaptive OLA) circuit is proposed for a zero-padding OFDM system to solve the above mentioned problem. Please refer to FIG. 3. FIG. 3 shows the block diagram of an adaptive OLA circuit 300 applied in a receiver of zero-padding OFDM system (not shown) according to an embodiment of the invention. The adaptive OLA circuit 300 comprises a detection unit (e.g. matched filer or Packet Detector) 310, a length estimator 320, and-an OLA circuit 330. The Packet Detector 310 estimates the current channel properties (e.g. Channel Impulse Response). The length estimator 320 estimates a post-cursor length as a new OLA length in the current OFDM symbol according to the channel, properties. The length estimator 320 further, comprises estimation units 322 and 324, and a calculation unit 326. A detailed description of the length estimator 320 will be described later. The OLA circuit 330 then copies the OLA length estimated from channel properties to the beginning of the FFT window. Further description of dynamic OLA is provided as follows:

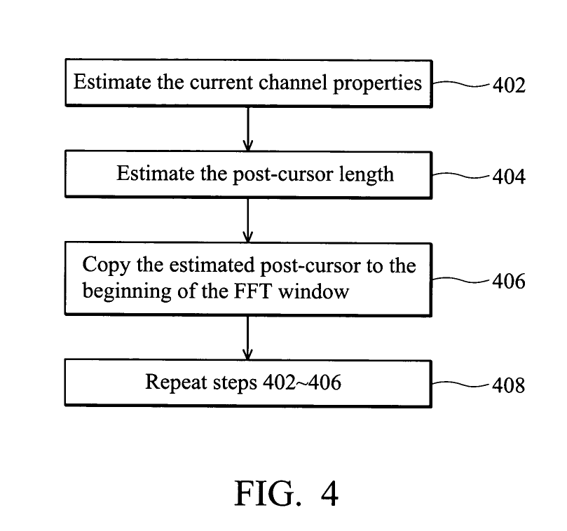

Please refer to FIG. 3 and FIG. 4 at the same time. FIG. 4 is a flowchart illustrating the adaptive Overlap and Add method utilized in the adaptive OLA circuit 300 according to another embodiment of the invention. A detailed description is provided as follows:
Step 402: Estimate the current channel properties according to a received OFDM signal by the Matched Filter or the Packet Detector.
Step 404: Estimate a post-cursor length according to the channel properties (e.g. Channel Impulse Response).
Step 406: Copy the estimated post-cursor to the beginning of the FFT window according to the post-cursor length.
Step 408: Repeat steps 402-406.

In the beginning, the-receiver utilizes the detection unit 310 to estimate the Channel Impulse Response ĥᵢ (step 402). The Channel Impulse Response ĥᵢ is shown as follows:

$${\hat{h}}_{i} = \frac{1}{{N}_{1} {σ}_{s}^{2}} {\sum }_{k = \hat{θ} + i}^{\hat{θ} + {N}_{1} + i - 1} r ( k ) {s}^{*} ( k - i - \hat{θ} )$$

where r(.) is the received OFDM signal, s(.) is Preamble coefficients in the transmitted OFDM signal, N₁ is the length of zero-padding, and σ²₂ is the received signal power. After estimating the Channel Impulse Response ĥᵢ, the receiver calculates the FFT window index \hat{θ} and the channel power index \hat{P} to further estimate the post-cursor length according to the Channel Impulse Response ĥᵢ. The indexes \hat{θ} and \hat{P} respectively estimated from the estimation units 322 and 324 are shown as follows:

$$\hat{θ} = {arg max}_{\hat{θ}} {\vert {\sum }_{k = \hat{θ} + i}^{\hat{θ} + {N}_{1} + i - 1} r ( k ) {s}^{*} ( k - i - \hat{θ} ) \vert}^{2}$$

$$\hat{P} = max {\sum }_{k = p}^{{N}_{m} + P - 1} {\vert {\hat{h}}_{k} \vert}^{2}$$

Where the FFT window index \hat{θ} represents a position time index where the channel has a maximal Channel Impulse Response value, which can be used to find the FFT window, and the channel power index \hat{P} represents another position time index where the summation of channel power value reaches a maximum. Furthermore, the channel power index \hat{P} can notify the OFDM symbol position time index. The post-cursor in the current OFDM symbol can be found as follows:
{r(k)|\hat{P}<k<\hat{θ}}

The calculation unit 326 then estimates the post-cursor length, which is exactly equal to the distance of two indexes \hat{θ} and \hat{P} (step 404), and copies-the estimated post-cursor to the beginning of the FFT window (step 406). Since the above process (step 402˜406) is repeated and repeated (step 408), the receiver can always find the best FFT window (one boundary is in the position of index \hat{θ}) and the OLA signal S_OLA even though channel properties (Channel Impulse Response) change with time. A detailed description of dynamic OLA operation in the time variant channel is provided as follows:

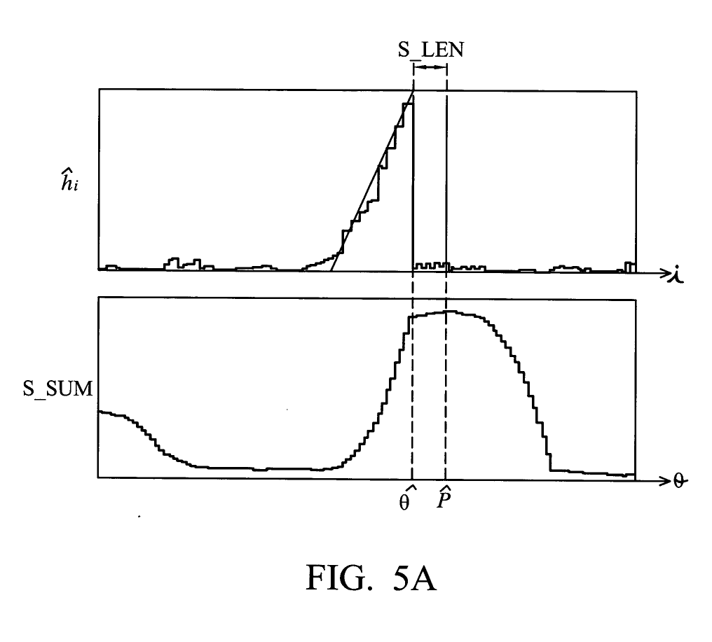

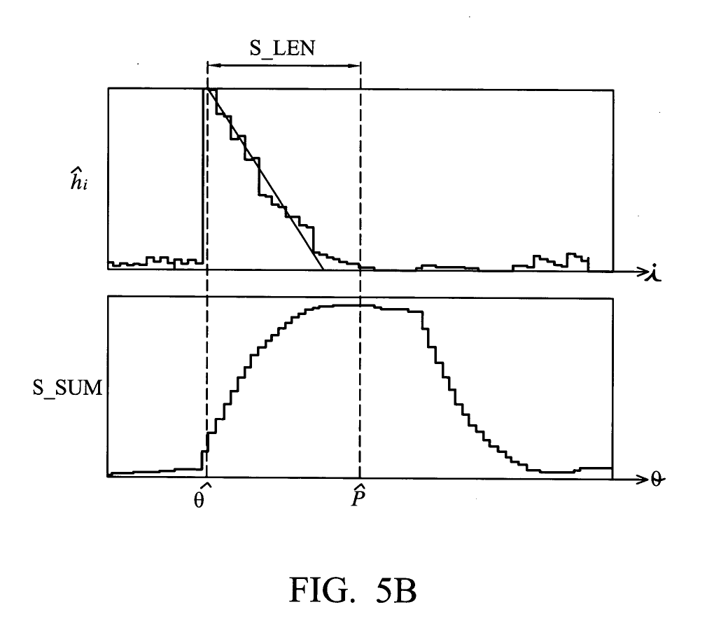

Please refer to FIG. 5A and FIG. 5B at the same time. FIG. 5A and FIG. 5B show waveform of the estimated power of Channel Impulse Response |ĥᵢ|² and its corresponding summation signal S_SUM according to the invention. In FIG. 5A, an estimated rising-triangle Channel Impulse Response is shown, which represents a pure pre-cursor channel. In FIG. 5B, another different estimated falling-triangle Channel Impulse Response is shown, which represents a pure post-cursor channel. It can be observed that the post-cursor length S_LEN estimated from the length estimator 320 varies with different Channel Impulse Response.

Compared with the related art, the adaptive OLA circuit of the invention can adaptively modify the OLA length and ensure that the OLA technology never operates improperly.

While the invention has been described by way of example and in terms of the preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An adaptive OLA circuit for a zero-padding OFDM system, said zero-padding OFDM system comprises a transmitter, a channel, and a receiver, said transmitter transmits an OFDM signal and the receiver receives the OFDM signal through the channel, said OFDM signal comprises a plurality of OFDM symbols, each OFDM symbol comprises post-cursors, an FFT window, and pre-cursors, lengths of the pre-cursors and the pre-cursors are dependent on a channel property of the channel, said adaptive OLA circuit comprising:
A detection unit for estimating the channel property according to the OFDM signal received through the channel;
An estimator for estimating an OLA length in a current OFDM symbol of the OFDM signal according to the channel property; and
An OLA circuit for copying an OLA signal to the FFT window in the current symbol according to the OLA length.

2. The adaptive OLA circuit according to claim 1, where the detection unit is a Matched Filter.

3. The adaptive OLA circuit according to claim 1, where the detection unit is a Packet Detector.

4. The adaptive LOLA circuit according to claim 1, where the channel property is a Channel Impulse Response.

5. The adaptive OLA circuit according to claim 4, where the OLA length is the post-cursor length, the OLA signal is the post-cursor, and the post-cursor is copied to a beginning of the FFT window.

6. The adaptive OLA circuit according to claim 5, where the estimator further comprises:
a first estimation unit for estimating a position time index where the channel has a maximal Channel Impulse Response value to output an FFT window index \hat{θ} according to the Channel Impulse Response;
a second estimation unit for estimating another position time index where a summation of channel power value reaches a maximum to output a channel power index \hat{P} according to the Channel Impulse Response; and
a calculation unit for calculating a distance of these two indexes \hat{θ} and \hat{P} to output the post-cursor length.

7. The adaptive OLA circuit according to claim 6, where these two indexes \hat{θ} and \hat{P}, and the Channel Impulse Response ĥᵢ are shown in the following:
$$\hat{θ} = {arg max}_{θ} {\vert {\sum }_{k = θ + i}^{θ + {N}_{1} + i - 1} r ( k ) {s}^{*} ( k - i - θ ) \vert}^{2} , \\ \hat{P} = max {\sum }_{k = p}^{{N}_{m} + P - 1} {\vert {\hat{h}}_{k} \vert}^{2} , \\ {\hat{h}}_{i} = \frac{1}{{N}_{1} {σ}_{s}^{2}} {\sum }_{k = \hat{θ} + i}^{\hat{θ} + {N}_{1} + i - 1} r ( k ) {s}^{*} ( k - i - \hat{θ} ) .$$

8. An adaptive OLA method for an adaptive OLA circuit in a zero-padding OFDM system, said zero-padding OFDM system comprises a transmitter, a channel, and a receiver, said transmitter transmits an OFDM signal and the receiver receives the OFDM signal through the channel, said OFDM signal comprises a plurality of OFDM symbols, each OFDM symbol comprises post-cursors, an FFT window, and pre-cursor segments, lengths of the pre-cursors and the pre-cursors are dependent on a channel property of the channel, comprising:
Estimating the channel property according to the OFDM signal received through the channel;
Estimating an OLA length in a current OFDM symbol of the OFDM signal according to the channel property; and
Copying an OLA signal to the FFT window in the current symbol according to the OLA length.

9. The adaptive OLA method according to claim 8, where the channel property is a Channel Impulse Response.

10. The adaptive OLA method according to claim 9, where the OLA length is the post-cursor length, the OLA signal is the post-cursor, and the post-cursor is copied to a beginning of the FFT window.

11. The adaptive OLA method according to claim 10, where the step of estimating the OLA length further comprises:
Estimating a position time index where the channel has a maximal Channel Impulse Response value to output an FFT window index \hat{θ} according to the Channel Impulse Response;
Estimating another position time index where a summation of channel power value reaches a maximum to output a channel power index \hat{P} according to the Channel Impulse Response; and
Calculating a distance of these two indexes \hat{θ} and \hat{P} to output the post-cursor length.

12. The adaptive OLA method according to claim 11, where these tow indexes \hat{θ} and \hat{P} and the Channel Impulse Response ĥᵢ are shown in the following:
$$\hat{θ} = {arg max}_{θ} {\vert {\sum }_{k = θ + i}^{θ + {N}_{1} + i - 1} r ( k ) {s}^{*} ( k - i - θ ) \vert}^{2} , \\ \hat{P} = max {\sum }_{k = p}^{{N}_{m} + P - 1} {\vert {\hat{h}}_{k} \vert}^{2} , \\ {\hat{h}}_{i} = \frac{1}{{N}_{1} {σ}_{s}^{2}} {\sum }_{k = \hat{θ} + i}^{\hat{θ} + {N}_{1} + i - 1} r ( k ) {s}^{*} ( k - i - \hat{θ} ) .$$

13. A zero-padding OFDM system comprising:
A transmitter for transmitting an OFDM signal;
A channel; and
A receiver for receiving the OFDM signal through the channel, where the receiver comprises an adaptive OLA circuit comprising:
A detection unit for estimating the channel property according to the OFDM signal received through the channel;
An estimator for estimating an OLA length in a current OFDM symbol of the OFDM signal according to the channel property; and
An OLA circuit for copying an OLA signal to the FFT window in the current symbol according to the OLA length;
Where the OFDM signal comprises a plurality of OFDM symbols, each OFDM symbol comprises post-cursors, an FFT window, and pre-cursor segments, lengths of the pre-cursors and the pre-cursors are dependent on a channel property of the channel.
